(19) United States
(12) Patent Application Publication
(10) Pub. No.: US 2010/0296987 A1
(43) Pub. Date: Nov. 25, 2010

(54) Method for the Recovery of Gold from a Gold-Containing Solution

(75) Inventors: Olli Hyvärinen, Pori (FI); Jussi Liipo, Ulvila (FI); Reijo Tontti, Pori (FI); Matti Hämäläinen, Legal Representative (FI); Tuula Hämäläinen, Pori (FI)

Correspondence Address: BUCHANAN, INGERSOLL & ROONEY PC, POST OFFICE BOX 1404, ALEXANDRIA, VA, 22313-1404, US

(73) Assignee: Outotec Oyi, Espoo (FI)

(21) Appl. No.: 11/884,117

(22) PCT Filed: Feb. 14, 2006
(86) PCT No.: PCT/FI06/00048

§ 371 Date: May 3, 2010

(30) Foreign Application Priority Data
Feb. 16, 2005 (FI) 20050177

(51) Int. Cl. B01D 15/08; B01D 15/02

(52) U.S. Cl. 423/25

(57) ABSTRACT

The invention relates to a method for the recovery of gold from a gold-containing chloride solution using activated carbon. The gold-containing solution and the carbon are contacted with each other, after which the gold that has formed as metallic particles on the surface of the carbon is separated from the carbon using physical methods as gold concentrate that contains metallic gold.

### FIELD OF THE INVENTION

The invention relates to a method for the recovery of gold from a gold-containing chloride solution by means of activated carbon. The gold-containing solution and the carbon are contacted with each other, after which the gold that has formed as metallic particles on the surface of the carbon is separated from the carbon using physical methods as gold concentrate that contains metallic gold.

### BACKGROUND OF THE INVENTION

One method for recovering gold from a concentrate or other gold-containing material is to recover gold in connection with the pyrometallurgical processing of the concentrate. Another method is to get the gold in soluble form. The leaching of gold-containing material can be performed in various ways. One of the most common is cyanide leaching, in which gold dissolves in water in the presence of cyanide and an oxidant.

Gold recovery from cyanide leaching often takes place using carbon. Recovery methods include the CIC, CIP and CIL methods. In the CIC or Carbon-In-Column method a dilute gold-containing solution is routed through several columns, which hold a fluidized bed formed of carbon. The method is advantageous, particularly when there are solids in the solution. The CIP or Carbon-In-Pulp method is a variation of the conventional cyanide process, where after leaching with cyanide normal solids separation is not carried out, but instead the slurry is routed to an agitated reactor with activated carbon. In practice there are five or six agitated tank reactors where the slurry and carbon are contacted on the countercurrent principle. The carbon adsorbs the gold in the solution onto its surface and the gold-containing carbon is removed from the solution by screening. The CIL or Carbon-In-Leach method is a combination of leaching and the CIP method in a single process.

In this case leaching reactors are fitted with carbon retention screens and separate CIP reactors are not required. Another conventional method is to feed the gold-containing solution through a column filled with activated carbon, onto which the gold is adsorbed.

Gold is usually recovered from activated carbon in the methods mentioned above by elution i.e. by leaching it into cyanide solutions. Known elution processes include the Zadra and AARL processes, which are described in U.S. Pat. No. 6,679,984. For instance in the Zadra process a solution containing 1-2% NaCN and 1-2% NaOH circulates through a carbon bed at a temperature above 85° C. Complete elution takes about 48 hours. Gold is recovered from the eluate for example by zinc precipitation or electrolysis. The methods have the use of cyanide in common. An essential part of the methods is the regeneration of carbon, which involves a washing stage and thermal activation stage, which is carried out in a furnace at 700° C.

WO publication 2004/059018 describes a chloride-based gold process, in which dissolved gold is adsorbed onto activated carbon, but gold recovery from the carbon occurs by means of cyanide leaching.

The use of toxic cyanide is essential to the methods mentioned above, as is the fact that the gold is adsorbed onto the surface and pores of activated carbon. In addition the method requires chemical elution and the precipitation of gold from the eluate either chemically or electrolytically. It is also essential that the activated carbon be regenerated in two steps: first by solution purification and then by thermal treatment in a furnace.

### PURPOSE OF THE INVENTION

According to the invention, gold is first precipitated with a chloride-based method from solution onto activated carbon. After that, the gold is separated from the carbon by means of physical methods as a highly concentrated metal-containing gold concentrate. The drawbacks related to known methods, such as the use of toxic cyanide, a gold reduction stage and carbon regeneration stage, are avoided with this method.

### SUMMARY OF THE INVENTION

The essential features of the invention are those presented in the attached claims.

The invention relates to a method whereby the gold in a chloride-containing solution is first contacted with activated carbon and precipitated as metallic particles on the surface of the activated carbon. After that, the gold formed as metallic particles is separated from the activated carbon by means of physical separation methods.

Contact between activated carbon and gold-containing chloride solution can be achieved in various types of equipment known as such. These include a series of carbon-containing columns comprising at least one column, where the carbon bed is either fixed or moving. Carbon may also be fed into a series of reactors comprising at least one reactor, where the carbon moves by means of the solution flow, gravity or mechanical mixing such as in an agitated reactor. The contact time of the carbon and solution is regulated either with the solution feed or carbon return or both, so that the gold particles grow large enough for physical separation. During physical separation an amount of the gold particles equivalent to the gold feed is separated from the carbon as a concentrate containing a large amount of metallic gold. The waste from separation is returned to the column or reactor system.

Physical separation comprises two stages in principle: the detachment of gold particles and the concentration of gold particles using gravity. In systems in which the carbon moves, the detachment of the gold particles from the carbon occurs partially during gold precipitation, when the carbon particles collide with each other, the walls of the equipment and the mixers.

Detachment also occurs during material transfer, for instance as the particles move through the pump or piping that changes its direction. In a column, where the carbon bed remains in place, the gold has to be detached either separately using ultrasound, by abrasion or during physical gravity separation.

The physical concentration method of free gold is a method based on gravity separation or specific weight separation. Such methods are centrifugal separation (Knelson or Falcon separator), spiral separation, shaking, vibration, hydroseparation or an equivalent method, with which gold particles with their greater specific weight are separated from activated carbon, which has a smaller specific weight.

### LIST OF DRAWINGS

FIG. 1 presents the flow chart of one embodiment of the invention, where contact between gold and activated carbon takes place in a reactor and a subsequent thickener.

### DETAILED EXPLANATION OF THE INVENTION

The gold separation method of the invention is based on microscope observations made during research on the HydroCopper™ process (U.S. Pat. No. 6,007,600), according to which gold leached in a chloride environment precipitates from the solution by the action of activated carbon as metal, probably in accordance with the following chemical reaction:

4AuCl₃+6H₂O+3C→4Au°+12HCl+3CO₂ (1)

In addition it was found that gold precipitates as metal particles in here and there on the surface of activated carbon—presumably on the more active points of the surface in one way or another. The gold particles grow individually at first and, when the conditions are suitable, form aggregates composed of several particles as growth proceeds, which can be loosened and separated from the carbon by simple physical means. The findings were followed by further testing, in which it was possible to precipitate gold from the solution with continuous laboratory equipment and produce concentrate containing as much as 84% gold by simple physical gravity separation from the activated carbon.

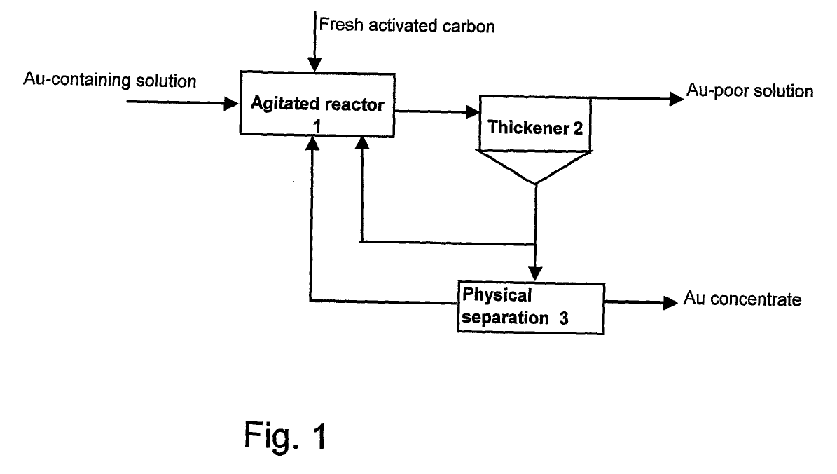

In the method now developed the gold-containing solution is routed to the agitated reactor 1 used as an example in FIG. 1, into which activated carbon is also fed. The number of reactors in this case is one, but there may also be several of them, in which case they form a series of reactors. The gold- and carbon-containing slurry is routed from the reactor or series of reactors to the thickener 2, the underflow of which is in turn routed to gravity separation 3, from where the lighter carbon-containing part is returned to the reactor. The solids content of the reactor is kept at a level sufficient for gold precipitation by means of the underflow return. Using of the return stream also increases the delay time of the nucleated gold particles on the carbon surface in the gold recovery stage. An extended delay time means that the particle size of the gold particle grows and becomes more suitable for gravity separation.

Gravity separation of the carbon and gold is performed on such a large amount of carbon that the amount of gold that was fed in is extracted from the process. Depending on the Au content of the feed solution, physical separation can be made either as a continuous process or only at intervals.

Where an agitated reactor is concerned, a separate detachment stage may not be necessary, since the gold particles are loosened from the carbon as a result of the agitator. When material transfer occurs by means of a pump or piping that changes its direction, detachment also occurs in there. Should extra detachment be necessary in addition to the loosening that occurs in the agitated reactor and the equipment attached to it, it can be made as a separate stage for example by means of ultrasound or abrasion.

Some method based on gravity separation, i.e. specific weight separation, is used as the physical concentration method of the free gold. Besides being a concentration method, gravity separation also acts partly as a detachment method. Methods based on gravity separation are centrifugal separation (Knelson or Falcon separator), spiral separation, shaking, vibration, hydroseparation or some other equivalent method, where gold particles with their greater specific weight are separated from activated carbon, which has a smaller specific weight. Thus the fabrication of the final gold concentrate is carried out by gravity separation.

The precipitation of gold onto carbon was described above as it occurs in an ordinary agitated reactor. Instead of an agitated reactor, other reactors can also be used, which are used in cyanide methods and where the carbon is in constant motion. These include the gravity cascade system, the closed tank adsorption system and the fluidized bed system in its various forms.

A column, which is simpler in construction and use than an agitated reactor, also works in gold recovery. The number of columns can be one or several, so that they form a series of columns. For the sake of simplicity we use the term a series of columns in the application, which comprises at least one column. The column may be any known type of construction. In one preferred embodiment, the carbon bed is fixed (a fixed bed adsorber) and it may also be pressurised. In another type of column the carbon bed is moved in pulses (a moving or pulse bed adsorber). One other type of column is a deep fluidized bed column.

The physical separation of gold can also be used as described above for the concentration treatment of gold-containing carbon recovered in a column. When the carbon bed in the column or series of columns is fixed, it is advantageous to use a separate gold particle detachment stage. As stated above, this can be made by means of ultrasound or abrasion, for instance.

After gravity separation, the gold concentrate obtained from the process in accordance with the invention is processed further e.g. by smelting or with chemical methods.

### EXAMPLES

### Example 1

A study was made of the recovery of gold from solution onto activated carbon with continuous laboratory apparatus, which was composed of a column made of glass and equipped with a heat jacket, with an inner diameter of 4 cm and a height of 90 cm. A porous base plate made of sintered glass was made in the column, on top of which was a 60 cm high bed of activated carbon. The average particle size of the activated carbon was 1.5 mm.

A solution that contained 60 g of Cu²⁺ as chloride and 260 g of NaCl/L as well as 5 mg/L gold added as Au³⁺ chloride, was fed into the column, which had an operating temperature of 80° C. at varying rates (see Table 1). The feed was made from above downwards.

TABLE 1

| | | | Average Au |
|---|---|---|---|
| Period | Duration | Feed | (mg/L) of product |
| No: | (h) | (L/h) | solution |
| 1 | 20 | 0.5 | <0.005 |
| 2 | 10 | 1.0 | 0.015 |
| 3 | 73 | 2.0 | 0.004 |
| 4 | 165 | 3.0 | 0.66 |

According to Table 1 the average amount of gold in the column carbon at the end of the test run was on average approx. 0.9% Au. Structural studies showed that the gold appeared on the surfaces of the carbon granules in places as metallic grains and agglomerates formed of said grains. The sizes of the grains and agglomerates varied between less than a micrometre (μm) and several tens of micrometres.

Gravity separation tests were performed on the gold-containing carbon with a hydroseparator, with which it is possible to separate a heavy mineral fraction appearing in minerals in very small quantities on the basis of specific weight. The result obtained was gold concentrate containing up to 37% Au.

### Example 2

A study was made of the recovery of gold from solution onto activated carbon with continuous laboratory apparatus, which was composed of a reactor equipped with a mixer and a thickener equipped with a rake. The overflow volumes of the reactor and thickener were 2 and 3.5 litres respectively and the temperatures 80° C. and 50° C.

A solution containing 60 g of Cu²⁺ as chloride and 260 g of NaCl/L as well as varying amounts of gold added as Au³⁺ chloride was fed into the reactor at a rate of 1 L/h. A total of 300 g of activated carbon was placed in the apparatus at the start of the test, with a grain size of 90% less than 0.01 mm. 140 g of the carbon was placed in the reactor and 160 g in the thickener. The gold concentration of the feed solution was kept at 5 mg/L for 12 hours, and after that at a level of 30 mg/L for 12 hours, then again at 5 mg/L for 12 hours and so on. The purpose of varying the gold concentration was to speed up the rise in gold content of the carbon and at the same time to get an understanding of the effect of the rise on the ability of the carbon to remove gold from solution.

The test run took 3 weeks altogether à 5 days à 24 h=360 h. During this time the thickener underflow was returned to the reactor in batches at a rate of 0.4 L/h. The purpose of the return was to keep the carbon content in the reactor high enough to ensure a good precipitation yield of gold, i.e. to exploit the carbon as effectively as possible.

Table 2 shows the Au content of the solution analysed from thickener overflow samples during the test run. It shows that the carbon functioned well throughout the test run. The variation is due to the above-mentioned periodic variations in the Au concentration of the feed solution between values of 5 and 30 mg/L.

TABLE 2

| | | Thickener overflow | | |
|---|---|---|---|---|
| | | Au (mg/L) | | |
| Day | Hour | Week 1 | Week 2 | Week 3 |
| Monday | 06 | 0.30 | | 1.34 |
| | 18 | 0.18 | | |
| Tuesday | 06 | 0.42 | 0.28 | 1.68 |
| | 18 | 0.30 | 0.32 | 0.10 |
| Wednesday | 06 | 0.70 | 1.26 | 0.72 |
| | 18 | 0.22 | 0.36 | 0.06 |
| Thursday | 06 | 0.62 | 1.14 | 0.68 |
| | 18 | 0.10 | 0.26 | 0.08 |
| Friday | 06 | 0.30 | 1.30 | 0.18 |
| | 18 | 0.01 | 0.14 | |
| Minimm | | 0.01 | 0.14 | 0.06 |
| Average | | 0.32 | 0.63 | 0.61 |
| Maximum | | 0.70 | 1.30 | 1.68 |

When the test run ended, the carbon was taken out of the apparatus, washed and dried. The analysis of the samples taken from the carbon showed 1.2-1.7% Au. The microstructural studies of the samples showed that the gold had precipitated as fine-grained and pure gold particles here and there on the surface of the carbon particles. The particles act as a nucleus and grow as gold precipitation proceeds even into idiomorphic cubic gold crystals. As precipitation continues, the size of the grains increased and the grains accumulated together forming larger agglomerates. The sizes of the grains and agglomerates varied between less than a micrometre (μm) and several hundreds of micrometres.

Gravity separation tests were performed on the gold-containing carbon with a hydroseparator, with which it is possible to separate a heavy mineral fraction appearing in minerals in very small quantities on the basis of specific weight. The result obtained was gold concentrate containing up to 58% Au.

### Example 3

A study was made of the recovery of gold from solution onto activated carbon using continuous laboratory apparatus as in example 1 in the way used in example 1, but using another grade of activated carbon. With this carbon, of which the D(50%) grain size was 0.04-0.05 mm and the volume weight 450 g/L, even slightly better results were achieved regarding the Au content of the solution and carbon, and in gravity concentration tests gold concentrate containing as much as 84% Au was achieved from the carbon containing approx. 2% Au taken from the test system at the end of the test run.

1. A method for recovering gold from a chloride-containing solution by means of activated carbon, characterised in that gold-containing chloride solution and carbon are brought into contact with each other, after which the gold that has formed as metallic particles on the surface of the carbon is separated from the carbon using physical separation methods as gold concentrate.

2. A method according to claim 1, characterised in that the gold-containing chloride solution and carbon are contacted in a series of columns comprised of at least one column.

3. A method according to claim 2, characterised in that the carbon bed of the column is fixed.

4. A method according to claim 2, characterised in that the carbon bed of the column is moving.

5. A method according to claim 1, characterised in that the chloride solution and carbon are contacted with each other in a series of reactors comprised of at least one reactor.

6. A method according to claim 5, characterised in that the reactor is an agitated reactor.

7. A method according to claim 1, characterised in that the physical separation of the gold particles from the activated carbon consists of the loosening of the gold particles and the concentration of the detached particles by means of gravity separation.

8. A method according to claim 7, characterised in that the detachment of the gold particles from the activated carbon occurs by means of ultrasound.

9. A method according to claim 7, characterised in that the detachment of the gold particles from the activated carbon occurs by abrasion.

10. A method according to claim 7, characterised in that when the gold-containing solution and the activated carbon are contacted in an agitated reactor, the detachment of the gold particles from the activated carbon takes place mainly in connection with mixing and material transfer.

11. A method according to claim 7, characterised in that the detachment of the gold particles from the activated carbon takes place in connection with gravity separation.

12. A method according to claim 7, characterised in that gravity separation to attain a gold-rich product is carried out using at least one of the following methods: centrifugal separation, spiral separation, shaking, vibration and/or hydroseparation.

13. A method according to claim 1, characterised in that the further processing of the gold concentrate is carried out by smelting.

14. A method according to claim 1, characterised in that the further processing of the gold concentrate is carried out by chemical means.
